(19) United States
(12) Patent Application Publication
(10) Pub. No.: US 2017/0042314 A1
(43) Pub. Date: Feb. 16, 2017

(54) CORDLESS SCREWDRIVER ASSEMBLY WITH ARM STOCK HAVING SHOULDER REST AND SLING

(71) Applicants: Tim Helton, Cloverdale, IN (US); Johnny Helton, Kodak, TN (US)

(72) Inventors: Tim Helton, Cloverdale, IN (US); Johnny Helton, Kodak, TN (US)

(21) Appl. No.: 14/824,200

(22) Filed: Aug. 12, 2015

(51) Int. Cl. A45F 3/14; A45F 3/12; B25B 21/00; B25F 5/02; B25F 5/00

(52) U.S. Cl. CPC A45F 3/14; B25F 5/02; B25F 5/008; B25B 21/00; A45F 3/12; A45F 2003/142

(57) ABSTRACT

A screwdriver assembly includes a cordless screwdriver with a drill body and a handle. The drill body includes a chuck and defines a cooling air inlet and a cooling air outlet. The handle includes a trigger movable between an on position that activates an electric motor to rotate the chuck about a rotation axis, and an off position. An arm stock includes an elongate body separating a first end from a second end. The first end includes a body coupler connected to the drill body and a handle coupler connected to the handle. The second end includes a shoulder rest shaped and sized to contact a shoulder of a user. The arm stock includes a shoulder sling for suspending the screwdriver assembly from the shoulder of the user.

### TECHNICAL FIELD

The present disclosure relates generally to cordless screwdriver assemblies, and more particularly to an arm stock that permits the user to apply a shoulder force along a drill axis.

### BACKGROUND

In the building trades, workers are sometimes required to utilize a cordless screwdriver to attach hundreds of fasteners in a single day. For instance, when constructing pole buildings, metal buildings and in some roofing applications, a worker may be required to attach sheet metal to underlying wood at hundreds of attachment locations. These attachment efforts may require the use of relatively long self tapping screws that require considerable force to both bore through the sheet metal and then the wood, and also thread the fastener through both. After many repetitions, a worker's arm muscles can become so fatigued that accidents can occur, fasteners can become improperly attached, and a workers muscles may become so fatigued that the work must be discontinued before an end of shift.

The present disclosure is directed toward one or more of the problems set forth above.

### SUMMARY

In one aspect, a screwdriver assembly includes a cordless screwdriver with a drill body and a handle. The drill body includes a chuck and defines a cooling air inlet and a cooling air outlet. The handle includes a trigger movable between an on position that activates an electric motor to rotate the chuck about a rotation axis, and an off position. An arm stock includes an elongate body separating a first end from a second end. The first end includes a body coupler connected to the drill body of the cordless screwdriver, and a handle coupler connected to the handle. The second end includes a shoulder rest shaped and sized to contact a shoulder of a user. The arm stock includes a shoulder sling for suspending the screwdriver assembly from the shoulder of the user.

In another aspect, an arm stock for attachment to a cordless screwdriver includes an elongate body separating a first end from a second end. The first end includes a body coupler for connecting the elongate body to a drill body, and a handle coupler for connecting the elongate body to a handle of a cordless screwdriver. The second end includes a shoulder rest shaped and sized to contact a shoulder of a user. A shoulder sling is included for suspending a screwdriver assembly from a shoulder of the user. The elongate body defines an air inlet passage for fluid connection to a cooling air inlet of the cordless screwdriver.

In another aspect, a method of attaching a piece of sheet metal to a piece of wood includes loading a self tapping screw on a bit received in the chuck of a screwdriver assembly. The tip of the self tapping screw is placed into contact with the sheet metal. The shoulder rest of the screwdriver assembly is placed in contact with the shoulder of the user. The trigger of the cordless screwdriver is moved from the off position to the on position. The self tapping screw is pressed into the sheet metal and then the wood while the trigger is in the on position by applying a force from the shoulder to the shoulder rest along the rotation axis of the cordless screwdriver.

### BRIEF DESCRIPTION OF THE DRAWINGS

FIG. 1 is a side schematic view of a screwdriver assembly according to the present disclosure;

FIG. 2 is an overhead view of a user attaching sheet metal to wood using the screwdriver assembly of FIG. 1

FIG. 3 is a perspective schematic view of an arm stock from the screwdriver assembly of FIG. 1; and

FIG. 4 is a front view of a user with the screwdriver assembly of FIG. 1 suspended from the user's shoulder.

### DETAILED DESCRIPTION

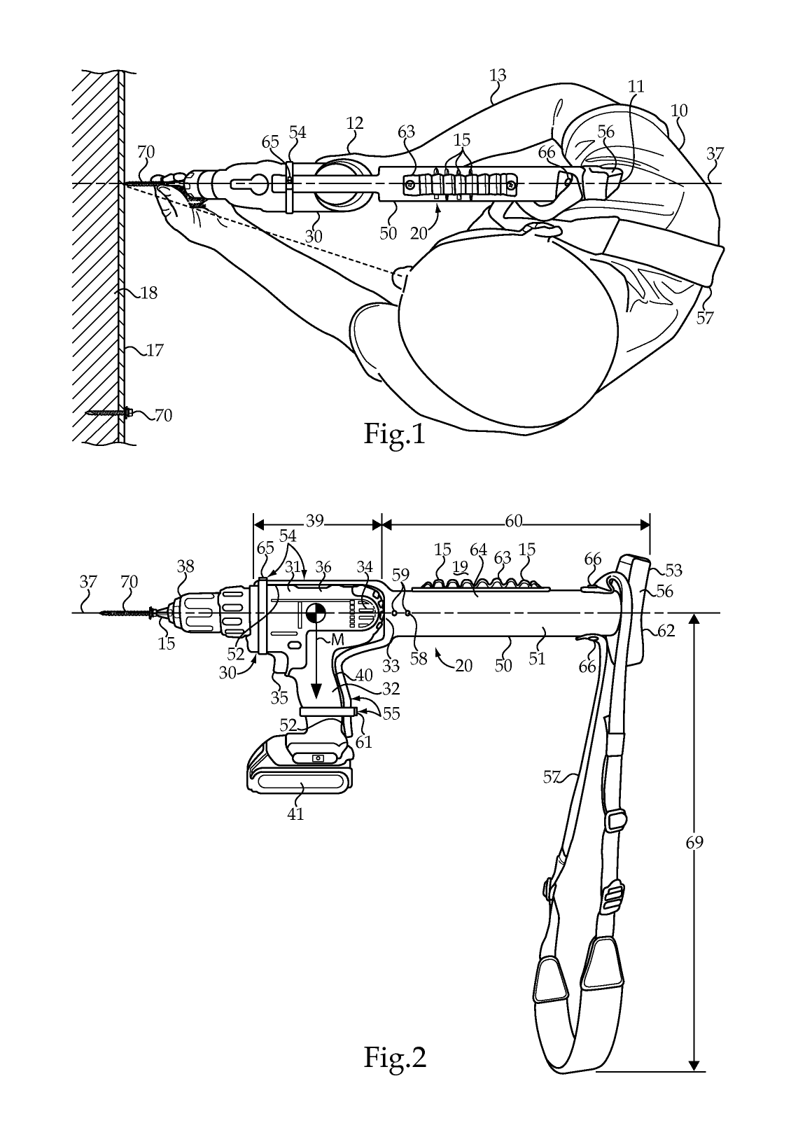

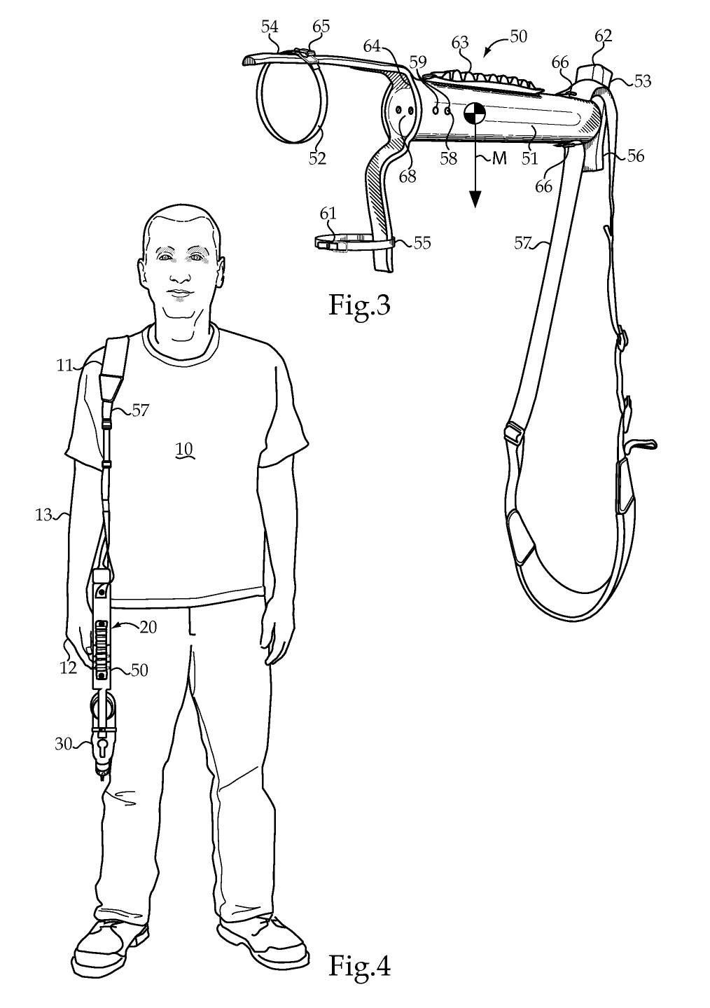

Referring to FIG. 1-4, a screwdriver assembly 20 includes an ordinary cordless screwdriver 30 connected to an arm stock 50. Cordless screwdriver 30 includes a drill body 31 oriented generally orthogonal to a handle 32. The drill body includes a chuck 38 and defines a cooling air inlet 33 and a cooling air outlet 34. Cooling air inlet 33 may be located on the back side of cordless screwdriver 30, and thus hidden from view in FIG. 1 and covered by arm stock 50. Handle 32 includes a trigger 35 that is movable between an on position that activates an electric motor 36 positioned inside drill body 31 to rotate the chuck 38 about a rotation axis 37, and an off position as shown. Cordless screwdriver 30 may be more commonly known as a cordless drill that normally includes a detachable and rechargeable battery 41. It is referred to in this disclosure as a cordless screwdriver 30 because a bit 15 is received and held in chuck 38. Those skilled in the art will appreciate that bit 15 may have a hex head socket end, a Phillips screwdriver end or any other suitable end adapted to mate to the head of an appropriate fastener, which are well known in the art. Cordless screwdrivers suitable for use in the present disclosure are manufactured or sold by, among others, Dewalt, Milwaukee Tools and many others.

Arm stock 50 includes an elongate body 51 that separates a first end 52 from a second end 53. The first end 52 includes a body coupler 54 connected to the drill body 31, and a handle coupler 55 connected to the handle 52. The second end 53 includes a shoulder rest 56 shaped and sized to contact a shoulder 11 of a user 10, as best shown in FIG. 2. The arm stock 50 also includes a shoulder sling 57 for suspending the screwdriver assembly 20 from the shoulder 11 of the user 10, as best shown in FIG. 4. Body coupler 54 may be as simple as ordinary tape that is wrapped around drill body 31 and an extension portion of body coupler 54. Likewise, handle coupler may also include ordinary tape. However, in the illustrated embodiment, both body coupler 54 and handle coupler 55 include quick disconnect features so that arm stock 50 may be quickly detached and reattached to cordless screwdriver 30. For instance, a handler coupler 55 may include a quick disconnect 61 in the form of a quick disconnect hose clamp that encircles handle 32. Likewise, body coupler 54 is shown as including a quick disconnect 65 in the form of a quick disconnect hose clamp sized to encircle the barrel of drill body 31. As used in this disclosure, “quick disconnect” means a mechanical connection that can repeatedly be disconnected and reconnected non destructively in a manner well known in the building construction arts. Nevertheless, those skilled in the art will appreciate that numerous other strategies could be utilized to couple arm stock 50 to cordless screwdriver 30. For example, straps with or without hook and loop fasteners could also be utilized as portions of the couplers. Furthermore, a portion of the attachment feature may be incorporated into cordless screwdriver 30 without departing from the scope of the present disclosure. For instance, cordless screwdriver 30 could be manufactured to include threaded studs or the like that could allow a quick threaded attachment as part of the body coupler 54 and handle coupler 55. Thus, any detachable mechanical connection would fall within the scope of the present disclosure.

Although not necessary, the arm stock 50 may have a total mass m that is less than a total mass M of the cordless screwdriver 30. In addition, arm stock 50 may have a length dimension 60 along rotation axis 37 that is greater than a drill body length 39 of cordless screwdriver 30. Finally, the shoulder sling 57, which may be adjustable in length 69, and may include a soft pad 62 for the user's shoulder 11, is longer than the length dimension 60 of the elongate body, or may be adjustable to be longer. These mass and dimensional relationships could be different without departing from the present disclosure.

Arm stock 50 may at least partially cover the cooling air inlet 33, and at least partially define an inlet passage 58 that fluidly connects that cooling air inlet 33 to a space 19 outside of screwdriver assembly 20. This feature of arm stock 50 may also serve to help prevent the cooling air inlet 33 from becoming obstructed by debris by the inclusion of numerous openings 59 in elongate body 51 as a portion of the inlet passage 58.

Although the shoulder rest 56 may be rigid, it may include a pad 62 that is softer than elongate body 51 in order to provide additional comfort to user 10. In addition, a bit holder 63 may be attached to elongate body 51 and be sized to received and hold a plurality of bits 15 that are sized to be received by the chuck 38. Although not necessary, elongate body 51 may comprise a hollow tube 64, such as a segment of plastic or PVC tubing or aluminum tubing. Elongate body 51 may have a circular cross section, or any other cross section without departing from the scope of the present disclosure. The rotation axis 37 may extend within the hollow tube, and intersect the shoulder rest 56 in order to better facilitate a force line of action between a user's shoulder 11 and a fastener 70 loaded on bit 15. In the illustrated embodiment, fastener 70 may take the form of a self tapping screw so that the user may in one motion drill through sheet metal 17 and into wood 18 as best shown in FIG. 2 and in a manner well known in the art. When elongate body 51 does include a hollow tube 64, a segment 68 of the air inlet passage 58 may extend within the hollow tube 64.

The bulk of arm stock 50 may be constructed of PVC tubing such that at least a portion of each of the shoulder rest 56, the body coupler 54 and the handle coupler 55 are integral with hollow tube 64. As used in this disclosure, the term integral means that the named features have never been separate and are formed from, in this example, a single segment of PVC tubing (e.g. two inch PVC). Nevertheless, aluminum tubing or other materials could be substituted without departing from the present disclosure. However, by using PVC, an extension portion of the handle coupler 55 may be shaped to match and contact a curved contour 40 along a back side of the handle 32 of cordless screwdriver 30 in order to provide a more secure connection and not undermine a user's pistol grip hold on handle 32 when screwdriver assembly 20 is being operated. An extension portion of drill coupler 54 may also be shaped to match a top surface of cordless screwdriver 30. Unlike a rifle when opposite ends of a sling are often connected to near the opposite ends of the rifle, sling 57 may be attached to elongate body 51 at a location 66 that is closer to the second end 53 than the first end 52. This configuration allows the screwdriver assembly 20 to be suspended from the shoulder 11 of a user 10 as best shown in FIG. 4, such as when moving from a first fastening location at a worksite to a second fastening location at a worksite on the piece of sheet metal 17 and piece of wood 18.

### INDUSTRIAL APPLICABILITY

The present disclosure finds general applicability as an accessory for commercially available cordless screwdrivers that enable the user to rely more on core body strength than arm strength when screwing fasteners 70, such as for attaching sheet metal 17 to wood 18, as in many metal buildings known in the art. The present disclosure finds specific applicability for workers who must properly position and screw in maybe hundreds of individual fasteners in a single day's work without having arm muscles become overly fatigued.

Referring to all of the Figs., a method of attaching a piece of sheet metal 17 to a piece of wood 18 includes loading a self tapping screw 70 on a bit 15 that has been received in chuck 38. The tip of the self tapping screw 70 is contacted with the sheet metal 70. Unlike a shooter aiming down the barrel, a user of a screwdriver assembly 20 may keep a line of sight view of the attachment point. Next, the shoulder rest 56 is put into contact with the shoulder 11 of a user 10. The trigger 35 is then moved from the off position to the on position. The user then presses the self tapping screw 70 into the sheet metal 17 and then the wood 18 while the trigger 35 is in the on position by applying a force from the shoulder 11 to the shoulder rest 56 along rotation axis 37. As the user 10 moves from one fastening location to another, the user may position sling 57 on their shoulder 11 as shown in FIG. 4. This allows the screwdriver assembly 20 to be suspended from the shoulder 11 while the user 10 moves from one fastening location to another with both hands free for other tasks such as carrying supplies or climbing a ladder. In some instances, bits 15 can wear out. The present disclosure allows for removal of a replacement bit 15 from bit holder 63. The user may then discard the worn out bit and replace it with the replacement 15 in chuck 38 and continue working with little to no downtime.

When in operation, one could expect cooling air to move through air inlet passage 58, which is at least partially defined by arm stock 50, to the cooling air inlet 33 of the cordless screwdriver 30. This cooling air can then exit cooling air outlet 34 in a normal manner and maintain motor 36 properly cooled for appropriate operation. In some instances, space may not permit usage of a complete screwdriver assembly 20. In such a case, the arm stock 50 may be separated from cordless screwdriver 30 by detaching body coupler 54 from drill body 31, and detaching handle coupler 55 from handle 32. For instance, this may be accomplished by moving the latches of quick disconnects 61 and 65 to an open position. The arm stock 50 may remain slung over the user's shoulder while the cordless screwdriver 30 is used in its typical hands only mode.

Although the present disclosure has been illustrated in the context of attaching sheet metal to wood, those skilled in the art will appreciate that the present disclosure could find potential application in relation to the use of any rotationally driven fasteners for attaching any known materials to one another. But the present disclosure finds specific benefit in enabling construction workers to use more core body muscles in attaching fasteners 70 when the worker may be required to attach hundreds in a single day.

The present description is for illustrative purposes only, and should not be construed to narrow the breadth of the present disclosure in any way. Thus, those skilled in the art will appreciate that various modification might be made to the presently disclosed embodiments without departing from the full and fair scope and spirit of the present disclosure. Other aspects, features and advantages will be apparent upon an examination of the attached drawings and appended claims.

What is claimed is:

1. A screwdriver assembly comprising:
a cordless screwdriver with a drill body and a handle, and the drill body including a chuck and defining a cooling air inlet and a cooling air outlet, and the handle including a trigger movable between an on position that activates an electric motor to rotate the chuck about a rotation axis, and an off position;
an arm stock with an elongate body separating a first end from a second end, and the first end including a body coupler connected to the drill body of the cordless screwdriver and a handle coupler connected to the handle, and the second end including a shoulder rest shaped and sized to contact a shoulder of a user; and
the arm stock including a shoulder sling for suspending the screwdriver assembly from the shoulder of the user.

2. The screwdriver assembly of claim 1 wherein the arm stock at least partially covers the cooling air inlet and at least partially defines an inlet passage that fluidly connects the cooling air inlet to a space outside of the screwdriver assembly.

3. The screwdriver assembly of claim 1 wherein the arm stock has less total mass than a total mass of the cordless screwdriver;
the arm stock has a length dimension greater than a drill body length dimension; and
the shoulder sling is longer than the elongate body.

4. The screwdriver assembly of claim 1 wherein the body coupler includes a quick disconnect; and
the handle coupler includes a quick disconnect.

5. The screwdriver assembly of claim 1 wherein the shoulder rest includes a pad that is softer than the elongate body; and
a bit holder attached to the elongate body that is sized to receive and hold a plurality of bits that are sized to be received by the chuck.

6. The screwdriver assembly of claim 1 wherein the elongate body includes a hollow tube;
the rotation axis extends within the hollow tube and intersects the shoulder rest.

7. The screwdriver assembly of claim 6 wherein the arm stock at least partially covers the cooling air inlet and at least partially defines an inlet passage that fluidly connects the cooling air inlet to a space outside of the screwdriver assembly, and a segment of the inlet passage is positioned within the hollow tube; wherein the shoulder rest includes a pad that is softer than the elongate body; and
a bit holder attached to the elongate body that is sized to receive and hold a plurality of bits that are sized to be received by the chuck;
the arm stock has less total mass than a total mass of the cordless screwdriver;
the arm stock has a length dimension greater than a drill body length dimension; and
the shoulder sling is longer than the elongate body.

8. An arm stock for attachment to a cordless screwdriver that includes a drill body and a handle, the arm stock comprising:
an elongate body separating a first end from a second end;
the first end including a body coupler for connecting the elongate body to the drill body, and a handle coupler for connecting the elongate body to the handle;
the second end including a shoulder rest shaped and sized to contact a shoulder of a user;
a shoulder sling for suspending the arm stock from the shoulder of the user;
the elongate body defining an air inlet passage for fluid connection to a cooling air inlet of the cordless screwdriver.

9. The arm stock of claim 8 wherein the elongate body includes a hollow tube; and
a segment of the air inlet passage extends within the hollow tube.

10. The arm stock of claim 9 wherein the shoulder sling is longer than the elongate body.

11. The arm stock of claim 10 wherein at least a portion of each of the shoulder rest, the body coupler and the handle coupler are integral with the hollow tube.

12. The arm stock of claim 11 including a bit holder attached to the hollow tube and being sized to receive and hold a plurality of bits for the cordless screw driver.

13. The arm stock of claim 12 wherein the shoulder rest includes a pad that is softer than the hollow tube.

14. The arm stock of claim 13 wherein a portion of the handle coupler is shaped to match and contact a curved contour of the handle of the cordless screwdriver.

15. The arm stock of claim 14 wherein the sling is attached to the hollow tube at a location closer to the second end than the first end.

16. A method of attaching a piece of sheet metal to a piece of wood with a screwdriver assembly that includes a cordless screwdriver with a drill body and a handle, and the body including a chuck and defining a cooling air inlet and a cooling air outlet, and the handle including a trigger movable between an on position that activates an electric motor to rotate the chuck about a rotation axis, and an off position; an arm stock with an elongate body separating a first end from a second end, and the first end including a body coupler connected to the drill body of the cordless screwdriver and a handle coupler connected to the handle, and the second end including a shoulder rest shaped and sized to contact a shoulder of a user; and the arm stock including a shoulder sling for suspending the screwdriver assembly from the shoulder of the user, and the method comprising the steps of:
loading a self tapping screw on a bit received in the chuck;
contacting a tip of the self tapping screw with the sheet metal;
contacting the shoulder rest with the shoulder of the user;
moving the trigger from the off position to the on position;
pressing the self tapping screw into the sheet metal and then the wood while the trigger is in the on position by applying a force from the shoulder to the shoulder rest along the rotation axis.

17. The method of claim 16 including positioning the sling on the shoulder of the user; and
suspending the screwdriver assembly from the shoulder while moving to a second fastening location of the piece of sheet metal and the piece of wood.

18. The method of claim 16 including removing a replacement bit from a bit holder attached to the elongate body of the arm stock; and
replacing the bit in the chuck with the replacement bit.

19. The method of claim 16 including moving cooling air through an inlet passage, which is at least partially defined by the arm stock, to a cooling air inlet of the cordless screwdriver.

20. The method of claim 16 including separating the arm stock from the cordless screwdriver by detaching the body coupler from the drill body; and
detaching the handle coupler from the handle.
